(19) United States
(12) Patent Application Publication
(10) Pub. No.: US 2025/0287468 A1
(43) Pub. Date: Sep. 11, 2025

(54) AEROSOL-GENERATING DEVICE WITH PLURAL POWER SUPPLIES

(71) Applicant: Philip Morris Products S.A., Neuchatel (CH)

(72) Inventors: Robert William EMMETT, Thame (GB); Jérôme Christian COURBAT, Cortaillod (CH)

(73) Assignee: Philip Morris Products S.A., Neuchatel (CH)

(21) Appl. No.: 18/861,723

(22) PCT Filed: Jul. 25, 2023
(86) PCT No.: PCT/EP2023/070561

§ 371 Date: Oct. 30, 2024

(30) Foreign Application Priority Data
Jul. 29, 2022 (EP) 22187799.6

(51) Int. Cl. H05B 3/00; A24F 40/10; A24F 40/40; A24F 40/57; H02J 7/00; H05B 1/02

(52) U.S. Cl. CPC H05B 3/0019; A24F 40/10; A24F 40/40; A24F 40/57; H02J 7/0025; H05B 1/0252; H05B 2203/021; H05B 2203/035

(57) ABSTRACT

An aerosol-generating device is provided, including: a first power supply and a second power supply; and electric circuitry including a controller to supply electrical energy from the first and the second power supplies to an electric heater, the first and the second power supplies are different types of power supplies, the first power supply being a Li-NMC, a Li-LCO, a Li-NCA, or a LiPo battery, the second power supply being a LiFePO₄ battery, the controller to provide power to the heater according to a predetermined heating profile including at least first and second heating stages in which a different amount of heating power is provided to the heater, the first heating stage being a preheating stage for preheating the at heater up to an operation temperature, and the second heating stage being an operation stage in which the device is configured to generate an inhalable aerosol.

The present invention relates to an aerosol-generating device comprising first and second power supplies. The present invention finds particular application as an aerosol-generating device forming part of an aerosol-generating system. The present invention also relates to a method for generating an aerosol in such aerosol-generating device.

One type of aerosol-generating system is an electrically operated aerosol-generating system. Known handheld electrically operated aerosol-generating systems typically comprise an aerosol-generating device comprising a battery, control electronics and an electric heater for heating an aerosol-forming substrate. The aerosol-forming substrate may be contained within part of the aerosol-generating device. For example, the aerosol-generating device may comprise a liquid storage portion in which a liquid aerosol-forming substrate, such as a nicotine solution, is stored. Alternatively, the aerosol-forming substrate may form part of a separate aerosol-generating article designed specifically for use with the aerosol-generating device. The separate aerosol-generating article may comprise the electric heater. In some examples, the aerosol-generating article comprises an aerosol-forming substrate, such as a tobacco rod or a tobacco plug, and the heater contained within the aerosol-generating device is inserted into or around the aerosol-forming substrate when the aerosol-generating article is inserted into the aerosol-generating device. In other examples, the aerosol-generating article comprises a heating arrangement where the article comprises a susceptor which is heated by one or more induction coils in the aerosol-generating device.

Typically, during a user experience electrical power is supplied according to a predetermined heating profile. Such heating profile may include at least two heating stages, including but not limited to a pre-heating stage and an operating stage. The pre-heating stage may be shorter than the operating stage. However, in the pre-heating stage, power consumption may be higher compared with the power consumption during the operating stage.

Since it is generally desirable to have an aerosol-generating device, which allows for providing multiple experiences, there is a general tendency to make use of batteries with large energy density. However, a high energy density battery may have a rather high internal resistance, which leads to internal power losses and which diminishes the potential number of user experiences.

It would be desirable to provide an aerosol-generating device having a power supply system, which allows to make efficient use of the stored electrical power.

It would be desirable to provide an aerosol-generating device having a power supply system, which allows to efficiently handle varying power demands during the different stages of a user experience.

It would be desirable to provide an aerosol-generating device having a power supply system, which allows to extend the available time period for a continuous user experience or even for multiple user experiences.

The aerosol-generating device according to the present invention comprises a first power supply and a second power supply. The aerosol-generating device further comprises an electric circuitry comprising a controller configured to supply electrical energy from the first power supply and the second power supply to an electric heater. The first power supply and the second power supply are different types of power supplies.

The controller is configured to supply electrical energy directly from the first power supply and directly from the second power supply to the at least one electric heater. Supplying the power directly from the first and the second power supply means that the power is provided directly from these power supplies to the heater, without being stored intermediately in a further storage unit or in one of the power supplies of the device. In particular, the electric power from the first power supply is not only provided to the second power supply and then provided from the second power supply to the heater. Such configurations are already known from the prior art in which for example a rechargeable battery is exclusively used to charge a capacitor and only the electric power from the capacitor is provided to the heater. Instead, in the present invention the controller is configured to provide electric power from both power supplies directly to the heater.

The controller is configured to supply electrical energy from the first power supply to the at least one electric heater not via the second power supply during at least one period during which the at least one electric heater is heated. The controller is configured to supply electrical energy from the second power supply to the at least one electric heater not via the first power supply during at least one period during which the at least one electric heater is heated.

With the expression “different type of power supply” it is not only meant that the two power supplies are different components or entities, but that these power supplies are power supplies that do have different nominal electrical characteristics or properties. These different nominal electrical characteristics or properties lead to different charging and de-charging behaviour of the power supplies. By using power supplies with different nominal electrical characteristics the power flow from the power supplies can be advantageously adapted to the instant power demands of the aerosolization process.

For example the power supplies may differ with respect to one or more of their construction, chemical composition, nominal energy density, their nominal internal resistance their nominal output voltage, their nominal output current and their nominal output power.

The first power supply may have a nominal energy density that is higher than a nominal energy density of the second power source. The controller may be configured to provide power from the first power supply when it is required to provide the electric heater with electrical power over an extended time period.

The first power supply may be a battery. The first power supply may be a battery with a high energy density. The first power supply may be a Li-Ion battery. The first power supply may be a lithium-manganese-cobalt-oxide (Li-NMC) battery. The first power supply may be a lithium-cobalt-oxide (LCO) battery. The first power supply may be a lithium-nickel-cobalt-aluminium-oxide (NCA) battery. The first power supply may be a lithium polymer (LiPo) battery. Such power supplies may have an energy density of about 150 to 220 Watt Hours per Kilogram.

The first power supply may further be configured to supply power to the controller and to any other electronic components of the aerosol-generating device.

Power supplies having a high energy density may have a comparably higher internal resistance than other types of power supplies. High internal resistances may have drawbacks when a high current is drawn from them.

When the battery is connected to a load a current I is drawn. This current I depends on the output voltage of the battery, V_{bat}, and the total load, namely the sum of the internal battery resistance, Rᵢₙₜ, and the load resistance, R_{load}. The battery resistance Rᵢₙₜ depends on the battery chemistry used. The load resistance R_{load} mainly depends on the type of the load to which the electric current is applied. In an aerosol-generating device, the load resistance R_{load} may basically correspond to the heater resistance. The power, P, dissipated in a resistive element, R, is defined as:

$$P = R {I}^{2} \qquad ( 1 )$$

Thus, the dissipated power within a battery depends from the internal resistance Rᵢₙₜ, and crucially also from the square of the current drawn from it. Thus, high currents may lead to particularly increased power dissipation within a battery. High power drains may be detrimental in particular to batteries with high energy density and should therefore tried to be avoided.

At the beginning of the pre-heating stage, power dissipation within a battery may be particularly increased, since in this phase the resistive heater is still at ambient temperatures and therefore has a comparably low resistance. At room temperature, the typical resistance (R_{load}) of an electrical heater of a conventional aerosol-generating device may be approximately 1 Ohm. This value usually increases with rising temperature of the heater. The internal resistance Rᵢₙₜ of a conventional Li-NMC battery may be about 0.1 Ohm. The open-circuit voltage (i.e., without load), V_{bat}, of a Li-NMC battery fully loaded is 3.7 Volts. Thus, if a current of 3.8 Amperes is drawn, the power dissipated in Rᵢₙₜ and R_{load} are respectively of 1.44 W and 14.44 W. In such case, the power lost in Rᵢₙₜ represents 9% of the total consumed power in this example. Said otherwise, approximately 1/10th of the energy available is lost in the internal resistance of the battery. This reduces the energy available for powering the electrical heater. This in turn reduces the potential number of smoking experiences by the same factor. Additionally, it is known that the internal resistance Rᵢₙₜ of a battery increases with temperature. Since the battery tends to become warmer during high power drains, this leads to further energy dissipation during use.

In order to reduce such internal energy losses, the aerosol generating device comprises a second power supply having different nominal electronic characteristics. The second power supply may be a battery having an internal resistance which is lower than the internal resistance of the first power supply. The second power supply may be a LiFePO₄ battery. The second power supply may also be a super-capacitor.

The typical internal resistance of a LiFePO₄ battery is below 0.1 Ohm. The internal resistance of a super-capacitor is also below 0.1 Ohm and typically is even below 0.03 Ohm. The effective internal resistance of such power supplies can be further reduced by connecting power supplies in parallel. The typical internal resistance of such power supplies is therefore significantly lower than the internal resistances of typical other power supplies in particular lower than the internal resistances of Li-NMC batteries. Due to the low internal resistance, such power supplies are suited to deliver a comparably high current and thus a higher power than other power supplies.

Power supplies having a low internal resistance, may have an energy density of up to 90 to 120 Watt Hours per Kilogram. This energy density may be smaller than the energy density of a typical Li-NMC battery. However, since its internal resistance is lower compared to the first power supply, the second power supply may be better suited to provide high power drains for a short time period. During this short time period high currents may be delivered to the electric load, while the amount of the dissipated energy is reduced.

The controller of the aerosol-generating device may be configured to supply power to the electric heater from both of the power supplies. The controller may be configured to supply electrical power to the electrical heater depending on the instant power demand for the aerosolization process. The controller of the aerosol-generating device may comprise a microcontroller unit. The microcontroller unit may be configured to adjust the power supply from one or both of the power supplies to the electric heater.

The controller may be configured to supply electrical energy from the first power supply and the second power supply to the at least one electric heater at the same time or at different times. The controller may be configured to supply electrical energy from the first power supply and the second power supply to the at least one electric heater at the same time or at different times during a user experience or a heating profile for generating aerosol.

The controller may be configured to provide power to the electric heater of the aerosol-generating device according to a predetermined heating profile. The predetermined heating profile may comprise at least a first heating stage and a second heating stage. In the first heating stage of the heating profile a different amount of heating power may be provided to the electric heater as compared to the second heating stage. In the first heating stage a higher current and, thus, a higher amount of electrical power may be provided to the electric heater.

The first and second heating stages may also differ with respect to their duration. For example the first heating stage may be shorter than the second heating stage. The first heating stage may last up to 20 seconds. The first heating stage may last up to 30 seconds. The first heating stage may last up to 40 seconds. The second heating stage may last at least 60 seconds. The second heating stage may last at least 120 seconds. The second heating stage may last up to 300 seconds. The second heating stage may last up to 500 seconds.

The first heating stage may also be defined in terms of temperature thresholds to be reached. For example the first heating stage may last until a measured temperature reaches a predetermined threshold temperature. The first heating stage may last until the heater temperature reaches a predetermined threshold temperature.

The controller of the aerosol-generating device may be configured such that in the first heating stage power is supplied to the electrical heater from the second power supply. The controller of the aerosol-generating device may be configured such that in the first heating stage power is supplied to the electrical heater from both power supplies, from the first power supply and from the second power supply. By providing the required electrical power in the first heating stage from the second power source, internal power losses caused by the comparably larger internal resistance of the first power source are reduced. This effect is of course most significant, if the complete required power is provided by the second power source. However, this advantageous effect is also achieved, if the required electrical power is provided from both power supplies, from the first power supply and from the second power supply.

The first heating stage may be a pre-heating stage for preheating the electrical heater up to an operating temperature. The operating temperature is a temperature sufficient for generating an aerosol. In the pre-heating stage, the electric heater assembly including the aerosol-forming substrate has to be heated up from ambient temperature to the operating temperature. Accordingly, in the pre-heating stage it is required to provide a high amount of power in a relatively short time period. Thus, in the preheating stage high current drain occurs for a rather short time period.

The controller of the aerosol-generating device may further be configured such that during the second heating stage the power is supplied to the electrical heater from the first power supply, only. The second heating stage may be an operating stage in which the aerosol-generating device may be used for generating an inhalable aerosol. The current drain during the operating stage is usually smaller than the current drain in the pre-heating stage, since in the operating stage no significant temperature increase may be necessary, but the heater assembly needs to be provided with an amount of electric power which is sufficient to keep the heater assembly at the operating temperature. However, the operating stage typically lasts significantly longer than the pre-heating stage. Accordingly the overall energy supplied during the operation stage is usually higher than the energy supplied in the pre-heating stage. Using a power supply having a high energy density therefore advantageously allows to increase the usage time of the aerosol generating device during the operating stage.

The first power supply and the second power supply may be advantageously connected in parallel. Parallel connection of a plurality of power supplies having the same nominal voltages, but otherwise different electrical characteristics, may be well within the scope of the skilled person.

A parallel connection of the first power supply and the second power supply is also possible if the power supplies have different nominal voltages. In this case, however, it may be necessary that the electric circuitry of the aerosol-generating device comprises a voltage control. The voltage control may be a DC/DC converter to match the different nominal voltages of the first power supply and the second power supply. The voltage control could in turn be controlled by the controller of the aerosol-generating device.

The controller of the aerosol-generating device may be configured to control the supply of power from the first and second power supply via two switches. These switches may advantageously be configured as MOSFET switches, which are controlled by the controller of the aerosol-generating device.

Connecting plural power sources in parallel may lead to another advantage. Since the total current I corresponds to the sum of the currents/provided by the individual power source, the effective current drain at each power source may be significantly smaller than in the case if only one power source were to be used. Thus, less current is drawn from the individual power sources and the total energy dissipated in the two power sources is lower than the energy that would be dissipated internally if only one power source would be connected. This is due to the fact that power loss goes linearly with the resistance R, but goes squared with the current I as shown in equation (1) above.

The aerosol-generating device may further comprise a power connector for receiving electrical energy from an external power source. The charging process may be controlled according to any technique known to the skilled person.

The controller of the aerosol-generating device may be configured to control the re-charging process of the first and second power supply from the external power source. The controller of the aerosol-generating device may be configured to control the re-charging process such that the first and second power supplies are re-charged simultaneously. The controller of the aerosol-generating device may be configured to control the re-charging such that the first power supply is re-charged first. Re-charging the first power supply first may be advantageous since the first power supply is used for powering the control electronics of the aerosol-generating device. With a fully de-charged first power supply, no operation of the aerosol-generating device may be possible.

The controller may be further configured to control the re-charging such that the first power supply is used to re-charge the second power supply. Since the overall capacity of the first power supply may be higher than the capacity of the second power supply, the first power supply may be used for re-charging the second power supply. Using the first power supply for re-charging the second power supply has the additional benefit that such re-charging can continue even when the aerosol-generating device is detached from an external power supply. This increases usability of the device and thus enhances the user experience.

The internal energy losses due to energy dissipation within the first power supply are proportional to the current drain according to equation (1) provided above. Accordingly, it may be advantageous to keep the power drain from the first power source as low as possible. For this purpose, the controller may be configured to prevent re-charging of the second power supply form the first power supply, as long as electrical power is supplied from the first power supply to the electric heater. In other words, the controller may be configured to prevent re-charging of the second power supply form the first power supply, during the operation stage, in which the first power supply is used for supplying power to the electric heater.

However, depending on the user demands it may also be advantageous to have the controller configured to provide electric power from the first power supply simultaneously to the second power supply and to the electric heater. Although more energy may be dissipated internally in the first power supply, this configuration may have the additional benefit that the re-charging process of the second power source is completed earlier. A trade-off has to be found between re-charging speed of the second power supply and losses at the internal resistance of the first power supply.

The controller of aerosol-generating device may be arranged to initiate re-charging of the second power supply form the first power supply, if an output voltage of the second power supply drops below a threshold voltage. The charging threshold voltage may be configured to be at about 2.5 Volts. The charging threshold voltage may be configured to be at about 2.0 Volts. The charging threshold voltage may be configured to be at about 0 Volts.

As used herein, the term ‘user experience’ denotes the use of the device to generate aerosol. During a user experience the electric heater is activated and/or a predetermined heating profile for generating aerosol is applied. The user typically takes a plurality of puffs during a user experience. Duration of a user experience may depend on the user's preferences and may typically last up to about 300 seconds.

An airflow sensor may be configured to measure airflow through the aerosol-generating device to determine when a consumer is drawing on the aerosol-generating device or an aerosol-generating system comprising the aerosol-generating device. The controller may be configured to modify the rate at which electrical energy is supplied from the first power supply to the at least one heater based on a measured airflow through the aerosol-generating device. The controller may be configured to increase the rate at which electrical energy is supplied from the first power supply to the at least one heater when airflow through the aerosol-generating device is increased. The controller may be configured to decrease the rate at which electrical energy is supplied from the first power supply to the at least one heater when airflow through the aerosol-generating device is decreased.

In embodiments in which the at least one additional electrical component comprises at least one user input device, the at least one user input device may comprise at least one of a push-button input device, a capacitive input device, and an audio input device.

In embodiments in which the at least one additional electrical component comprises at least one feedback device, the at least one feedback device may comprise at least one of a LED, a LCD, a speaker, and a haptic feedback device.

The at least one electric heater may comprise at least one of a resistive heater and an inductive heater.

The aerosol-generating device may comprise a liquid storage portion and a liquid aerosol-forming substrate stored within the liquid storage portion. During use, the electric heater heats a small portion of the liquid aerosol-forming substrate to vaporize the small portion of the liquid aerosol-forming substrate. The liquid aerosol-forming substrate preferably comprises a tobacco-containing material comprising volatile tobacco flavour compounds which are released from the liquid upon heating. Alternatively, or in addition, the liquid aerosol-forming substrate may comprise a non-tobacco material. The liquid aerosol-forming substrate may include water, solvents, ethanol, plant extracts and natural or artificial flavours. Preferably, the liquid aerosol-forming substrate further comprises an aerosol former.

As used herein, the term ‘aerosol former’ is used to describe any suitable known compound or mixture of compounds that, in use, facilitates formation of an aerosol. Suitable aerosol formers are substantially resistant to thermal degradation at the operating temperature of the aerosol-generating device. Examples of suitable aerosol formers are glycerine and propylene glycol.

The aerosol-generating device may further comprise a capillary wick in communication with the liquid storage portion. The capillary wick is arranged to be in contact with the liquid aerosol-forming substrate within the liquid storage portion. During use, liquid aerosol-forming substrate is transferred from the liquid storage portion along the capillary wick by capillary action, where it is heated by the electric heater. In embodiments in which the electric heater comprises an inductive heater, the aerosol-generating device may further comprise a susceptor. During use, the inductive heater heats the susceptor and liquid aerosol-forming substrate is transferred from the liquid storage portion to the susceptor via the capillary wick.

The aerosol-generating device may comprise a cavity for receiving an aerosol-generating article comprising an aerosol-forming substrate. The at least one electric heater may comprise an elongate heater configured for insertion into an aerosol-generating article when an aerosol-generating article is received within the cavity. The elongate heater may have any suitable shape to facilitate insertion into the aerosol-generating article. For example, the elongate heater may be a heater blade. The elongate heater is preferably a resistive heater.

The at least one heater may comprise a heater positioned adjacent to an outer surface of an aerosol-generating article when the aerosol-generating article is received within the cavity. The at least one heater may comprise a substantially annular heater configured to surround at least a portion of an aerosol-generating article when an aerosol-generating article is received within the cavity. The at least one heater may comprise a substantially planar heater positioned adjacent to an end of an aerosol-generating article when an aerosol-generating article is received within the cavity. The heater positioned adjacent to an outer surface of an aerosol-generating article when the aerosol-generating article is received within the cavity is preferably an inductive heater.

As used herein, the terms ‘inner’ and ‘outer’ are used to refer to relative positions of components of the aerosol-generating device, or parts of components of the aerosol-generating device. For example, an inner surface of a component faces toward an interior of the device and an outer surface of a component faces toward the exterior of the device.

The present invention also relates to an aerosol-generating system comprising an aerosol-generating device as described above, and the at least one electric heater configured for removable attachment to the aerosol-generating device. The aerosol-generating system may further comprise a cartridge, which comprises the at least one electric heater and an aerosol-forming substrate.

The aerosol-generating system may also comprise an aerosol-generating article and an aerosol-generating device as described above. The aerosol-generating article may comprise an aerosol-forming substrate. The aerosol-generating device preferably comprises a cavity for receiving the aerosol-generating article.

The aerosol-generating article may comprise a liquid storage portion and a liquid aerosol-forming substrate stored within the liquid storage portion. During use, the electric heater heats a small portion of the liquid aerosol-forming substrate to vaporize the small portion of the liquid aerosol-forming substrate. The liquid aerosol-forming substrate preferably comprises a tobacco-containing material comprising volatile tobacco flavour compounds which are released from the liquid upon heating. Alternatively, or in addition, the liquid aerosol-forming substrate may comprise a non-tobacco material. The liquid aerosol-forming substrate may include water, solvents, ethanol, plant extracts and natural or artificial flavours. Preferably, the liquid aerosol-forming substrate further comprises an aerosol former.

The aerosol-generating article may further comprise a capillary wick in communication with the liquid storage portion. The capillary wick is arranged to be in contact with the liquid aerosol-forming substrate within the liquid storage portion. During use, liquid aerosol-forming substrate is transferred from the liquid storage portion along the capillary wick by capillary action, where it is heated by the electric heater. In embodiments in which the electric heater comprises an inductive heater, the aerosol-generating article may further comprise a susceptor. During use, the inductive heater heats the susceptor and liquid aerosol-forming substrate is transferred from the liquid storage portion to the susceptor via the capillary wick.

The aerosol-generating article may comprise a solid aerosol-forming substrate. The aerosol-forming substrate may comprise tobacco. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise tobacco-containing material and non-tobacco containing material. In embodiments in which the electric heater comprises an inductive heater, the aerosol-generating article may further comprise a susceptor. Preferably, the susceptor is positioned within the aerosol-forming substrate.

The aerosol-forming substrate may include at least one aerosol-former. Suitable aerosol-formers include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The aerosol-forming substrate may have an aerosol former content of greater than 5 percent on a dry weight basis.

The aerosol-forming substrate may have an aerosol former content of between approximately 5 percent and approximately 30 percent on a dry weight basis.

The aerosol-forming substrate may have an aerosol former content of approximately 20 percent on a dry weight basis.

The aerosol-generating article may comprise an aerosol-forming substrate comprising a first aerosol-forming substrate comprising a nicotine source and a second aerosol-forming substrate comprising an acid source. In use, the electric heater heats the first and second aerosol-forming substrates to volatilise the nicotine and the acid so that the nicotine and acid are reacted together in the gas phase to form an aerosol of nicotine salt particles. In embodiments in which the electric heater comprises an inductive heater, the aerosol-generating article may further comprise a susceptor. Preferably, the susceptor is positioned to heat both the nicotine source and the acid source.

The nicotine source may comprise one or more of nicotine, nicotine base, a nicotine salt, such as nicotine-HCl, nicotine-tartrate, or nicotine-ditartrate, or a nicotine derivative.

The nicotine source may comprise natural nicotine or synthetic nicotine.

The nicotine source may comprise pure nicotine, a solution of nicotine in an aqueous or non-aqueous solvent or a liquid tobacco extract.

The nicotine source may further comprise an electrolyte forming compound. The electrolyte forming compound may be selected from the group consisting of alkali metal hydroxides, alkali metal oxides, alkali metal salts, alkaline earth metal oxides, alkaline earth metal hydroxides and combinations thereof.

For example, the nicotine source may comprise an electrolyte forming compound selected from the group consisting of potassium hydroxide, sodium hydroxide, lithium oxide, barium oxide, potassium chloride, sodium chloride, sodium carbonate, sodium citrate, ammonium sulfate and combinations thereof.

In certain embodiments the nicotine source may comprise an aqueous solution of nicotine, nicotine base, a nicotine salt or a nicotine derivative and an electrolyte forming compound.

The nicotine source may further comprise other components including, but not limited to, natural flavours, artificial flavours and antioxidants.

The acid source may comprise an organic acid or an inorganic acid. Preferably, the acid source comprises an organic acid, more preferably a carboxylic acid, most preferably lactic acid or an alpha-keto or 2-oxo acid.

Preferably, the acid source comprises an acid selected from the group consisting of lactic acid, 3-methyl-2-oxopentanoic acid, pyruvic acid, 2-oxopentanoic acid, 4-methyl-2-oxopentanoic acid, 3-methyl-2-oxobutanoic acid, 2-oxooctanoic acid and combinations thereof. Preferably, the acid source comprises lactic acid or pyruvic acid.

The present invention also relates to a method for generating an aerosol in an aerosol-generating device as described herein, wherein the method comprises, supplying electrical energy from a first power supply and a second power supply to at least one electric heater. The electrical energy from the first power supply and from second power supply is provided to the heater either at the same time or at different times. The first power supply and the second power supply are different types of power supplies.

The controller may provide power to the heater according to a predetermined heating profile. The predetermined heating profile may comprise at least a first heating stage and a second heating stage. In the first heating stage the controller may supply a different amount of heating power to the electric heater electric than in the second heating stage.

The first heating stage may be a pre-heating stage for preheating the electrical heater from ambient temperature up to the operation temperature. In the preheating stage, power may be supplied the electric heater from the second power supply, which has a lower internal resistance and a lower energy density than the first power supply.

The second heating stage may be an operation stage in which the aerosol-generating device is used for generating an inhalable aerosol. In the operation stage, power may be supplied to the electric heater from the first power supply, which has a higher internal resistance and a higher energy density than the second power supply.

By supplying electric power to the heater from different power supplies in accordance with a predefined heating profile, internal energy losses might be reduced. Since in portable devices only a limited amount of energy is available, efficient use of the stored energy and in particular a reduction of energy losses allows for a longer usage time of the portable device.

The aerosol-generating device may further comprise a power connector for receiving electrical energy from an external power source. In this regard, the controller may control the re-charging process of the first and second power supply from the external power source. The controller may control the re-charging process such that the first power supply is used to re-charge the second power supply.

Below, there is provided a non-exhaustive list of non-limiting examples. Any one or more of the features of these examples may be combined with any one or more features of another example, embodiment, or aspect described herein.

Example 1: An aerosol-generating device comprising a first power supply and a second power supply, and electric circuitry comprising a controller configured to supply electrical energy from the first power supply and the second power supply to at least one electric heater, wherein the first power supply and the second power supply are different types of power supplies.

Example 2: The aerosol-generating device according to example 1, wherein the controller is configured to supply electrical energy directly from the first power supply and the second power supply to the at least one electric heater.

Example 3: The aerosol-generating device according to any preceding example, wherein the first power supply has a higher energy density than the second power source.

Example 4: The aerosol-generating device according to any preceding example, wherein the first power supply is a battery, preferably a battery with a high energy density, preferably a Li-Ion battery, preferably a Li-NMC, a Li-LCO, a Li-NCA or a LiPo battery.

Example 5: The aerosol-generating device according to any preceding example, wherein the first power supply is configured to supply power to the controller and any other electronic component of the aerosol-generating device.

Example 6: The aerosol-generating device according to any preceding example, wherein the second power supply is a battery having an internal resistance which is lower than the internal resistance of the first power supply.

Example 7: The aerosol-generating device according to any preceding example, wherein the second power supply is a LiFePo₄ battery or a super-capacitor.

Example 8: The aerosol-generating device according to any preceding example, wherein the first power supply and the second power supply are connected in parallel.

Example 9: The aerosol-generating device according to any preceding example, wherein the first power supply and the second power supply have different nominal voltages.

Example 10: The aerosol-generating device according to the preceding example, wherein the electric circuitry comprises a DC/DC converter to match the different nominal voltages of the first power supply and the second power supply.

Example 11: The aerosol-generating device according to any preceding example, wherein the controller comprises a microcontroller unit.

Example 12: The aerosol-generating device according to any preceding example, wherein the controller is configured to provide power to the heater according to a predetermined heating profile.

Example 13: The aerosol-generating device according to the preceding example, wherein the predetermined heating profile comprises at least a first heating stage and a second heating stage, wherein in the first heating stage and the second heating stage a different amount of heating power is provided to the electric heater.

Example 14: The aerosol-generating device according to any preceding example, wherein during the first heating stage the controller is arranged to supply power to the electrical heater from the second power supply.

Example 15: The aerosol-generating device according to any preceding example, wherein during the first heating stage the controller is arranged to supply power to the electrical heater from the first power supply and the second power supply.

Example 16: The aerosol-generating device according to any preceding example, wherein during the second heating stage the controller is arranged to supply power to the electrical heater from the first power supply, only.

Example 17: The aerosol-generating device according to any preceding example, wherein the first heating stage is a pre-heating stage for preheating the electrical heater up to an operation temperature.

Example 18: The aerosol-generating device according to any preceding example, wherein the second heating stage is an operation stage in which the aerosol-generating device is used for generating an inhalable aerosol.

Example 19: The aerosol-generating device according to any preceding example, wherein the controller is arranged to control the supply of power from the first and second power supply via two switches, preferably via two MOSFET switches.

Example 20: The aerosol-generating device according to any preceding example, wherein the aerosol-generating device further comprises a power connector for receiving electrical energy from an external power source, and wherein the controller is arranged to control re-charging of the first and second power supply from the external power source.

Example 21: The aerosol-generating device according to any preceding example, wherein the controller is arranged to control the re-charging such that the first and second power supply are re-charged simultaneously.

Example 22: The aerosol-generating device according to any preceding example, wherein the controller is arranged to control the re-charging such that the first power supply is re-charged first.

Example 23: The aerosol-generating device according to any preceding example, wherein the controller is arranged to control the re-charging such that the first power supply is used to re-charge the second power supply.

Example 24: The aerosol-generating device according to the preceding example, wherein the controller is arranged to prevent re-charging of the second power supply form the first power supply, as long as electrical power is supplied to the electric heater.

Example 25: The aerosol-generating device according to the preceding example, wherein the controller is arranged to simultaneously provide electric power from the first power supply to the second power supply and to the electric heater.

Example 26: The aerosol-generating device according to the preceding example, wherein the controller is arranged to initiate re-charging of the second power supply form the first power supply, if an output voltage of the second power supply drops below a threshold voltage.

Example 27: The aerosol-generating device according to the preceding example, wherein the threshold voltage is 2.5 Volts, wherein preferably the threshold voltage is 2.0 Volts, and wherein preferably the threshold voltage is 0 Volts.

Example 28: The aerosol-generating device according to any one of the preceding examples, further comprising the at least one electric heater.

Example 29: The aerosol-generating device according to any one of the preceding examples wherein the controller is configured to supply electrical energy from the first power supply and the second power supply to the at least one electric heater at the same time or at different times.

Example 30: The aerosol-generating device according to any one of the preceding examples wherein the controller is configured to supply electrical energy from the first power supply and the second power supply to the at least one electric heater at the same time or at different times during a user experience or a heating profile for generating aerosol.

Example 31: An aerosol-generating system comprising an aerosol-generating device according to any one of examples 1 to 30, and the at least one electric heater configured for removable attachment to the aerosol-generating device.

Example 32: The aerosol-generating system according to example 31 further comprising a cartridge which comprises the at least one electric heater and an aerosol-forming substrate.

Example 33: A method for generating an aerosol in an aerosol-generating device, the method comprising supplying electrical energy from a first power supply and a second power supply to at least one electric heater, wherein the electrical energy from the first power supply and from second power supply is provided to the heater either at the same time or at different times, and wherein the first power supply and the second power supply are different types of power supplies.

Example 34: The method according to example 33, wherein the controller provides power to the heater according to a predetermined heating profile.

Example 35: The method according to example 34, wherein the predetermined heating profile comprises at least a first heating stage and a second heating stage, and wherein in the first heating stage and the second heating stage a different amount of heating power is provided to the electric heater.

Example 36: The method according to example 35, wherein the first heating stage is a pre-heating stage for preheating the electrical heater to an operation temperature, and wherein in the preheating stage, power is supplied from the second power supply, which has a lower internal resistance and a lower energy density than the first power supply.

Example 37: The method according to examples 35 or 36, wherein the second heating stage is an operation stage in which the aerosol-generating device is used for generating an inhalable aerosol, and wherein in the operation stage, power is supplied from the first power supply, which has a higher internal resistance and a higher energy density than the second power supply.

Example 38: The method according to any one of example 33 or 37, wherein the aerosol-generating device further comprises a power connector for receiving electrical energy from an external power source, and wherein the controller controls re-charging of the first and second power supply from the external power source.

Example 39: The method according to the preceding example, wherein the controller controls the re-charging such that the first power supply is used to re-charge the second power supply.

Example 40: The method according to any one of examples 33 to 39 wherein the electrical energy from the first power supply and from second power supply is provided to the heater either at the same time or at different times during a user experience or a heating profile for generating aerosol.

Features described in relation to one aspect or embodiment may equally be applied to other aspects or embodiments of the invention. In particular, method aspects may be applied to apparatus aspects, and vice versa.

The invention will be further described, by way of example only, with reference to the accompanying drawings in which:

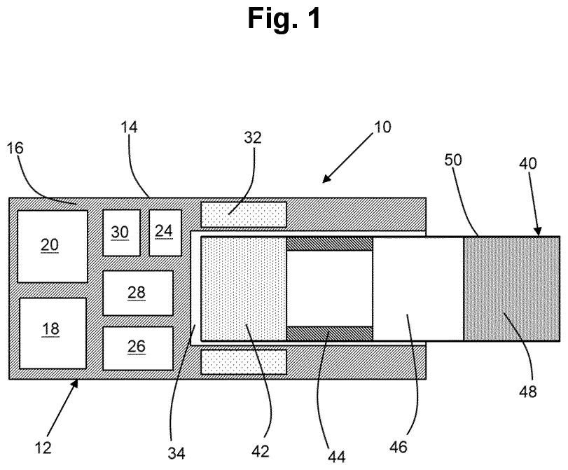

FIG. 1 shows an aerosol-generating system comprising an aerosol-generating device and an aerosol-generating article;

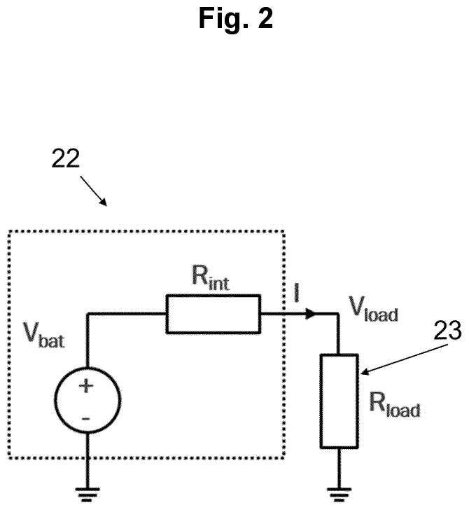

FIG. 2 shows an electronic scheme of a battery connected to a load;

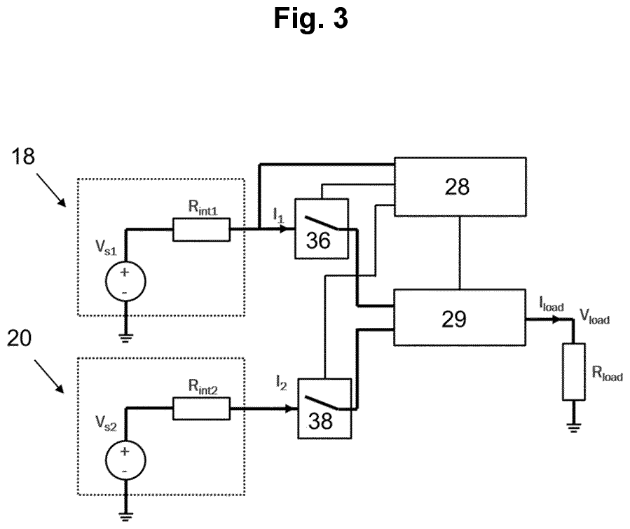

FIG. 3 shows an implementation of the power supply control in an aerosol-generating device in accordance with FIG. 1; and

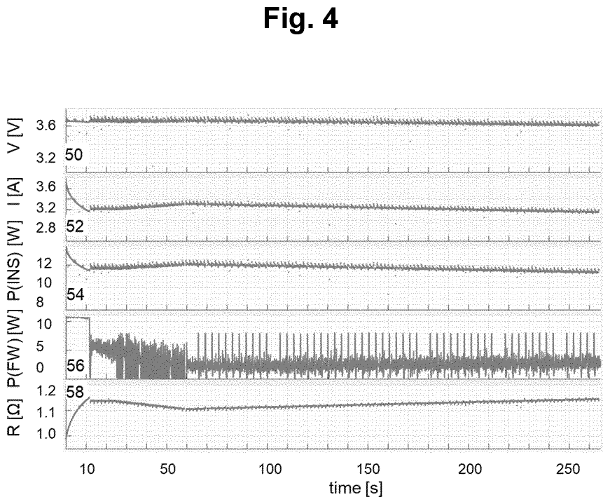

FIG. 4 shows various electrical signals from a battery during operation of an aerosol-generating device in accordance with FIG. 1.

FIG. 1 shows an aerosol-generating system 10 comprising an aerosol-generating device 12 and an aerosol-generating article 40. The aerosol-generating device 12 comprises a housing 14 defining an internal compartment 16.

The aerosol-generating device 12 comprises a first power supply 18 and a second power supply 20, an airflow sensor 24, a feedback device 26, a controller 28, an input device 30, and an electric heater 32, all positioned within the internal compartment 16. The electric heater 32 is an annular, resistive and external heater. The first power supply 18 is a Li-NMC (Lithium Nickel Manganese Cobalt Oxide) battery having a nominal output voltage of 3.6 Volts, an internal resistance of about 0.1 Ohm and an energy density of about 200 Watthours per kilogram (Wh/kg). The first power supply is configured to supply electrical energy to all electrical components of the aerosol-generating device, including the airflow sensor 24, the feedback device 26, the controller 28, the input device 30 and the electric heater 32.

The second power supply 20 is a LFP (Lithium Iron Phosphate) battery, having a nominal output voltage of 3.2 Volts, an internal resistance of about 0.01 Ohm and an energy density of about 100 Watthours per kilogram (Wh/kg). The second power supply 20 is configured to supply electrical energy to the electric heater 32.

The controller 28 is configured to control the supplies of electrical energy from the first and second power supplies 18, 20 to the other electrical components within the internal compartment 16.

The aerosol-generating system 10 further comprises an aerosol-generating article 40 that is received within a cavity 34 of the aerosol-generating device 12 during use. The aerosol-generating article 40 comprises an aerosol-forming substrate 42, a hollow acetate tube 44, a polymeric filter 46, a mouthpiece 48 and an outer wrapper 50. The aerosol-forming substrate 42 comprises a plug of tobacco and the mouthpiece 48 comprises a plug of cellulose acetate fibres.

During use, the controller 28 supplies electrical energy from the power supplies 18, 20 to the electric heater 32 to resistively heat the aerosol-forming substrate 42. The energy supply to the electric heater is controlled by the controller according to a pre-defined heating profile. This heating profile comprises at least a pre-heating stage and an operational stage. In the pre-heating stage, the heater is heated up from ambient conditions to about 220 degrees Celsius. The pre-heating stage is rather short and lasts for only about 25 seconds. In the operational stage the heater is heated further up to its operational temperature at about 240 degrees Celsius. The operational stage lasts until the user decides to stop the experience, and typically lasts for about 180 to 300 seconds.

In the operational stage the tobacco within the aerosol-forming substrate 42 is heated to the operational temperature, at which temperature volatile compounds are released from the tobacco for delivery to the user. The feedback device 26 is configured to provide feedback to the user with respect to the status of the operational mode of the aerosol-generating system.

FIG. 2 shows a schematic diagram of a battery 22 connected to a load 23. The battery 22 is schematically depicted to comprise a voltage source providing an output voltage V_{bat} and an internal resistance Rᵢₙₜ. The load 23 is depicted as a resistance R_{load}. The voltage V_{load} which is applied to the load 23 corresponds to the output voltage V_{bat} of the battery. When the battery 22 is connected to the load 23 a current I is drawn. This current depends on the voltage of the battery, V_{bat}, and the total load, namely the sum of the internal battery resistance, Rᵢₙₜ, and the load resistance, R_{load}. The former depends on the battery chemistry used and the latter mainly of the heater resistance. The power, P, dissipated in a resistive element is generally defined as P=R*I² (see equation (1) above). Thus, if high heating power is required a high heating current needs to be drawn from the battery. However, the higher the current drawn, from the battery the more power is also dissipated at the internal resistance of the battery.

A conventional resistive heater as used in the embodiment of FIG. 1 has a resistance of about 1 Ohm. The internal resistance of a Li-NMC battery is about 0.1 Ohm. Thus, the power dissipated at the internal resistance of the battery 22 in the schematic of FIG. 2 is about one tenth of the electric power stored in the battery 22. While the amount of energy that may be stored in a Li-NMC battery is increased, the high internal resistance is not favourable for drawing large currents from such battery.

Compared to a Li-NMC battery, a LFP battery may involve a lower energy density, but also has a lower internal resistance. Therefore, the dissipative energy loss is significantly reduced, in particular when a high current is to be delivered. High current is delivered in particular during the pre-heating stage of an aerosol-generating device. However, since the pre-heating stage lasts only for a limited time period, the overall energy required in the pre-heating stage is also limited. Electric energy stored in a LFP battery suitable for use in a portable device is sufficient to provide the electric heating power required during the pre-heating stage.

FIG. 3 shows a schematic illustrating the power supply system in an aerosol-generating system of FIG. 1. The first power supply 18 is a Li-NMC battery delivering a nominal voltage V_{S1} of about 3.7 Volts and having an internal resistance Rᵢₙₜ₁ of about 0.1 Ohm. This first power supply 18 is user to supply power to the controller 28. Additionally, first power supply 18 provides power to the electric heater during the operating stage. The electric power is delivered via switch 36.

The second power supply 20 is a LFP battery, delivering a nominal voltage V_{S2} of about 3.2 Volts and having a lower internal resistance Rᵢₙₜ₂ of below 0.01 Ohm. The second power supply is used when the heater resistance, R_{load}, is of low value, namely when it is cold. The second power supply is able to deliver a high power and a high current, I₂, for a rather short period of time, such as during pre-heating stage or a part of the pre-heating stage. The second power supply 20 provides power to the electric heater via switch 38.

The controller switches from the first power supply 18 to the second power supply 20 using the two switches 36, 38. The switches are MOSFET transistors. Since the nominal battery voltages V_{S1}, V_{S2} as well as the internal resistances Rᵢₙₜ₁, Rᵢₙₜ₂ are not identical the electronic circuitry in the aerosol-generating device includes a voltage control 29, which is controlled by the controller 28. The voltage control 29 comprises a DC/DC converter to match the voltages from the two power supplies 18, 20.

Connecting the batteries in parallel simultaneously may involve a lower impact of Rᵢₙₜ₁ and Rᵢₙₜ₂ as the required total current I_{load} would split between I₁ and I₂. Thus, less current is drawn from the individual batteries and the total energy dissipated in the two batteries is lower than the energy that would be dissipated internally if only one battery would be connected. This is due to the fact that power loss goes linearly with the resistance R, but goes squared with the current I as shown in eq. (1).

FIG. 4 shows electrical signals measured at the battery level in a typical aerosol-generating device as illustrated in FIG. 1. The displayed electrical signals in FIG. 4 correspond to the instantaneous battery voltage 50, instantaneous battery current 52, instantaneous power 54, averaged power 56 as measured by the device's firmware over a period of 50 milliseconds, and heater resistance 58.

FIG. 4 shows these electrical signals throughout a user experience lasting about 260 seconds. The first 25 seconds represent the pre-heating stage. During the preheating stage, the temperature of the heater is increased from ambient temperature to the pre-heating temperature of about 220 degrees Celsius. As can be seen in the diagram 58 the heater resistance 58 increases thereby from 1.0 Ohm to about 1.15 Ohms which represents an increase by 15 percent. Throughout the user experience the heater resistance 58 stays at this increased resistance level.

The electric heater is supplied with electric power using a pulse width modulation (PWM) mode. The supply of power is controlled by the firmware of the aerosol-generating device and is averaged during a period of 50 milliseconds. This averaged power is depicted in the graph 56 in FIG. 4. This averaged power value starts at its maximum defined in the firmware to be at 10.8 Watts. After about 10 seconds into the pre-heating stage, the averaged power level starts to decrease but still remains at an increased level throughout the pre-heating stage. The initial instantaneous power 54 was measured to amount to 13.5 Watts and decreased to 11.6 Watts after 12 seconds of preheating. During that time and with a duty cycle close to 100%, the battery is highly solicited, which means that a high current is drawn from the battery. This is also apparent from the instantaneous current 52 depicted in FIG. 4. At the beginning of the pre-heating stage, when the electric heater is still cold and has an electrical resistance of approximately 1 ohm, a instantaneous current of about 3.7 Amperes is drawn. The heater resistance reached its high value of about 1.15 ohm after the first 12 seconds in the pre-heating stage.

In a transition phase lasting from second 25 to 60, the averaged power 56 further decreases, which is indicative of a continuously reducing duty cycle. After 60 seconds of operation and until the end of the user experience, the averaged power 56 ranges between 2 and 3 Watts. However, due to the on/off mode of heater operation, the instantaneous power 54 still reaches higher values of about 11 to 12 Watts during this part of the operational stage. Due to the much lower duty cycle of only 20 to 30 percent during the operational stage, the battery has more time to recover between the pulses and is thus less solicited.

The instantaneous battery voltage 50 was rather constant during the user experience. The instantaneous battery voltage 50 was at level of 3.7 Volts at the start of the user experience and slightly decreased to 3.6 Volts towards the end of the user experience.

The high duty and the high current drain in the pre-heating phase, leads to high resistive losses and additionally may affect the lifespan of a Li-NMC battery. Supplying the electrical power in this phase, from a different type of battery, namely a LFP battery increases the user experience, since such batteries are better suited for delivering high amounts of electric power. Using Li-NMC battery, with a high energy density predominantly in the operational phase, allows for using the high amount of stored energy more efficiently, and may even allow for plural consecutive user experiences without the need for an intermediate recharge.

1.-13. (canceled)

14. An aerosol-generating device, comprising:
a first power supply and a second power supply; and
electric circuitry comprising a controller configured to supply electrical energy from the first power supply and the second power supply to at least one electric heater,
wherein the first power supply and the second power supply are different types of power supplies,
wherein the first power supply is a Li-NMC, a Li-LCO, a Li-NCA, or a LiPo battery,
wherein the second power supply is a LiFePO₄ battery,
wherein the controller is further configured to provide power to the at least one electric heater according to a predetermined heating profile,
wherein the predetermined heating profile comprises at least a first heating stage and a second heating stage,
wherein in the first heating stage and the second heating stage a different amount of heating power is provided to the at least one electric heater,
wherein the first heating stage is a preheating stage for preheating the at least one electric heater up to an operation temperature, and
wherein the second heating stage is an operation stage in which the aerosol-generating device is configured to generate an inhalable aerosol.

15. The aerosol-generating device according to claim 14, wherein the first power supply has a higher energy density than the second power supply.

16. The aerosol-generating device according to claim 14, wherein the first power supply is configured to supply power to the controller and any other electronic component of the aerosol-generating device.

17. The aerosol-generating device according to claim 14, wherein the second power supply is a battery having an internal resistance that is lower than an internal resistance of the first power supply.

18. The aerosol-generating device according to claim 14, wherein during the first heating stage the controller is further configured to supply power to the at least one electric heater from the second power supply.

19. The aerosol-generating device according to claim 14, wherein during the first heating stage the controller is further configured to supply power to the at least one electric heater from the first power supply and the second power supply.

20. The aerosol-generating device according to claim 14, wherein during the second heating stage the controller is further configured to supply power to the at least one electric heater only from the first power supply.

21. The aerosol-generating device according to claim 14, further comprising the at least one electric heater.

22. An aerosol-generating system comprising an aerosol-generating device according to claim 14, and the at least one electric heater configured for removable attachment to the aerosol-generating device.

23. A method for generating an aerosol in an aerosol-generating device, the method comprising:
supplying electrical energy from a first power supply and a second power supply to at least one electric heater,
wherein the electrical energy from the first power supply and from second power supply is provided to the at least one electric heater either at a same time or at different times,
wherein the first power supply and the second power supply are different types of power supplies,
wherein the first power supply is a Li-NMC, a Li-LCO, a Li-NCA, or a LiPo battery,
wherein the second power supply is a LiFePO₄ battery,
wherein a controller provides power to the at least one electric heater according to a predetermined heating profile comprising at least a first heating stage and a second heating stage,
wherein in the first heating stage and the second heating stage a different amount of heating power is provided to the at least one electric heater,
wherein the first heating stage is a preheating stage for preheating the at least one electric heater to an operation temperature,
wherein in the preheating stage, power is supplied from the second power supply, which has a lower internal resistance and a lower energy density than the first power supply,
wherein the second heating stage is an operation stage in which the aerosol-generating device is configured to generate an inhalable aerosol, and
wherein in the operation stage, power is supplied from the first power supply, which has a higher internal resistance and a higher energy density than the second power supply.
